(19) United States
(12) Patent Application Publication
(10) Pub. No.: US 2016/0247215 A1
(43) Pub. Date: Aug. 25, 2016

(54) METHOD OF PROVIDING RECOMMENDED DINING OPTIONS, METHOD OF SELECTING RECOMMENDED DINING OPTIONS AND ELECTRONIC APPARATUS, COMPUTER READABLE MEDIUM, SERVER APPARATUS THEREOF

(71) Applicant: HTC Corporation, Taoyuan City (TW)

(72) Inventors: Wendy Wai Mun Chan, San Francisco, CA (US); Pei-Ju Chen, Taoyuan City (TW)

(21) Appl. No.: 15/052,893

(22) Filed: Feb. 25, 2016

Related U.S. Application Data
(60) Provisional application No. 62/120,384, filed on Feb. 25, 2015.

(51) Int. Cl. G06Q 30/06; G06Q 10/10

(52) U.S. Cl. CPC G06Q 30/0631; G06Q 10/1095

(57) ABSTRACT

The disclosure provides a method of providing recommended dining options, an electronic apparatus and a computer readable medium using the same. The method adapted to the electronic apparatus includes following steps. An option query is transmitted to a server apparatus at a query time point, the option query includes location information of a first location where the electronic apparatus is located at the query time point. An option bundle sent from the server apparatus in response to the option query is received, where the option bundle includes one or more dining options comprising option information. The option information is displayed in at least one of regions of a user interface within a predetermined meal period, and the regions of the user interface are applied to display information content collected by the electronic apparatus. The disclosure also provides a method of selecting recommended dining options and a server apparatus thereof.

### CROSS-REFERENCE TO RELATED APPLICATION

This application claims the priority benefit of U.S. provisional application Ser. No. 62/120,384, filed on Feb. 25, 2015. The entirety of the above-mentioned patent application and U.S. patent application Ser. No. 61/709,997, U.S. patent application Ser. No. 61/750,339, U.S. patent application Ser. No. 61/812,217, and U.S. patent application Ser. No. 14/044,685, filed on Oct. 2, 2013 are hereby incorporated by reference herein and made a part of this specification.

### TECHNICAL FIELD

The disclosure relates to a method of providing recommended dining options, an electronic apparatus and a computer readable medium using the same. Further, the disclosure also relates to a method of selecting recommended dining options and a server apparatus using the same.

### BACKGROUND

In order to catch up with the quick pace for the modern life of the mass, more and more applications are installed and applied in electronic devices, such as smart devices, communication devices, and daily appliances, for instantaneously providing essential information and reminding important events and matters at anytime and anywhere. Through those applications, service providers of the network services, manufacturers of the electronic devices, and application developers of the applications bring convenience and sufficient information to users of the electronic devices from easily accessing to vast of the network resources.

The user of the electronic device may actively perform search or query for business service. To be more specific, the user may search or query the favourable business service on a search engine, and the aforementioned business service could be the restaurant or the store serving food. Specifically, during the meal time, the user may search for the restaurant that meets the demand of the user.

However, in many cases, the user is easily overwhelmed by the volume and scope of available information. For example, the user is often confused on choosing the place for food from the large amount of available dining options. As the result, an automatic recommendation mechanism for business services, especially the dining options, is thus required. Further, how to recommend the user with suitable dining option is now being a challenge for people in the related art.

### SUMMARY OF THE DISCLOSURE

Accordingly, the disclosure is directed to a method of providing recommended dining options, an electronic apparatus and a computer readable medium using the same, which suitable dining options are searched at least based on location information related to the electronic apparatus and displayed to the user of the electronic apparatus automatically within a predetermined meal period; thereby, a small set of information that is appropriate in the context of time and location will be presented to the user. The disclosure is further directed to a method of selecting recommended dining options and a server apparatus using the same.

An embodiment of the present disclosure is directed to a method of providing recommended dining options, wherein the method is adapted to an electronic apparatus connected to a server apparatus. The method includes following steps. An option query is transmitted to the server apparatus at a query time point. The option query includes location information of a first location where the electronic apparatus is located at the query time point. An option bundle sent from the server apparatus in response to the option query is received. The option bundle includes one or more dining options comprising option information. At least one of the dining options comprising the option information is displayed in at least one of the regions of a user interface within a predetermined meal period. Each region of the user interface is applied to display information content collected by the electronic apparatus.

An embodiment of the present disclosure is directed to an electronic apparatus, which is connected to a server apparatus. The electronic apparatus includes a processing unit, an input/output (I/O) interface, a transmission unit and a display unit. The I/O interface is coupled to the processing unit. The transmission unit coupled to the processing unit transmits an option query to the server apparatus at a query time point and receives an option bundle sent from the server apparatus in response to the option query. The option query includes location information of a first location where the electronic apparatus is located at the query time point, and the option bundle includes one or more dining options comprising option information. The display unit coupled to the processing unit displays at least one of the dining options comprising the option information in at least one of the regions of a user interface within a predetermined meal period. Each region of the user interface is applied to display information content collected by the processing unit.

An embodiment of the present disclosure is directed to a non-transitory computer readable medium, which records computer program to be loaded into an electronic apparatus to execute the steps of the aforementioned method of providing recommended dining options. The computer program is composed of a plurality of program instructions (for example, an organization chart, establishing program instruction, a table approving program instruction, a setting program instruction, and a deployment program instruction, etc.), and these program instructions are loaded into the electronic apparatus and executed by the same to accomplish various steps of the method of providing recommended dining options.

An embodiment of the present disclosure is directed to a method of selecting recommended dining options. The method adapted to a server apparatus connected to an electronic apparatus includes following steps. An option query transmitted from the electronic apparatus at a query time point is received. The option query includes location information of a first location where the electronic apparatus is located at the query time point. One or more dining options with option information are searched at least according to the location information of the first location. An option bundle is generated. The option bundle includes the dining options comprising the option information. The option bundle is transmitted to the electronic apparatus.

An embodiment of the present disclosure is directed to a server apparatus connected to an electronic apparatus. The server apparatus includes a transmission unit and a processing unit. The transmission unit receives an option query transmitted from the electronic apparatus at a query time point. The option query includes location information of a first location where the electronic apparatus is located at the query time point. The processing unit coupled to the transmission unit searches One or more dining options with option information at least according to the location information of the first location and generates an option bundle. The option bundle includes the dining options comprising the option information. The option bundle is transmitted to the electronic apparatus by the transmission unit.

In view of the aforementioned descriptions, the disclosure is directed to a technique for automatically recommending user of the electronic apparatus with suitable dining options. The dining options comprising the option information are searched at least based on the location information of the electronic apparatus and displayed though a user interface on the electronic apparatus within the predetermined meal period. Thus, the disclosure provides a convenient and instinctive recommendation mechanism.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating an electronic system according to an embodiment of the present disclosure.

FIG. 2 is a flowchart illustrating a method of providing recommended dining options according to an embodiment of the present disclosure.

FIG. 3 is a flowchart illustrating a method of selecting recommended dining options according to an embodiment of the present disclosure.

FIG. 4 is a schematic diagram illustrating displaying option information in regions of a user interface according to an embodiment of the present disclosure.

FIG. 5 is a flowchart illustrating steps of displaying option information in regions of a user interface according to an embodiment of the present disclosure.

FIG. 6A is a schematic diagram illustrating displaying a dining notification under a lockscreen state according to an embodiment of the present disclosure.

FIG. 6B is a schematic diagram illustrating launching a notification region under a lockscreen state according to an embodiment of the present disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

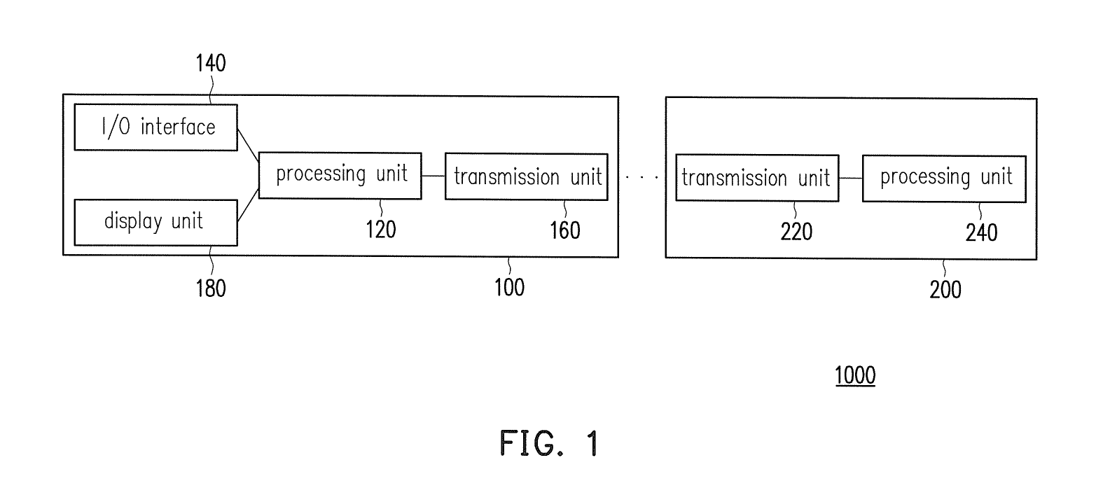

FIG. 1 is a block diagram illustrating an electronic system according to an embodiment of the present disclosure. The electronic system 1000 includes an electronic apparatus 100 and a server apparatus 200 connected to each other. The electronic apparatus 100 is capable of utilizing the proposed method of providing recommended dining options, and the server apparatus 200 is capable of utilizing the proposed method of selecting recommended dining options. However, the present disclosure is not limited herein. In another example, the proposed method of selecting recommended dining options may be executed by the electronic apparatus 100. The proposed methods of providing recommended dining options and selecting recommended dining options may further be respectively implemented by other suitable devices with/without a server apparatus. All components of the electronic systems 1000 and their configurations are first introduced in FIG. 1.

Referring to FIG. 1, in the present exemplary embodiment, the electronic apparatus 100 includes a processing unit 120, an input/output (I/O) interface 140, a transmission unit 160, and a display unit 180. The electronic apparatus 100 may be a smart phone, a tabular computer, a personal computer, a laptop computer, or other types of electronic devices or platforms that equipped with computation and communication abilities. In addition, the server apparatus 200 includes a transmission unit 220 and a processing unit 240. The server apparatus 200 may be a server computer, or other types of electronic devices or platforms that running the server program.

In an embodiment, the processing units 120 and 240 may respectively include one or more of a North Bridge, a South Bridge, a field programmable array (FPGA), a programmable logic device (PLD), an application specific integrated circuit (ASIC), a central processing unit (CPU), a programmable general purpose or special purpose microprocessor, a digital signal processor (DSP), a graphics processing unit (GPU), or other similar device or a combination thereof.

In an embodiment, the I/O interface 140 coupled to the processing unit 120 may include one or more of a keyboard, a mouse, a touch control panel, a speaker or other device that capable for performing input/output function or a combination thereof.

In an embodiment, the transmission units 160 and 220 may respectively include one or more of a wired communication interface, a wireless communication interface or a combination thereof. The wired communication interface includes one or more of a universal serial bus (USB), a RS232, a universal asynchronous receiver-transmitter (UART), an inter-integrated circuit (I2C), a serial peripheral interface (SPI), a display port, a thunderbolt, or a local area network (LAN) interface. The wireless communication interface supports one or more of a wireless fidelity (Wi-Fi) protocol, a Bluetooth protocol, a Bluetooth low energy (BLE) protocol, a near-field communication (NFC) protocol, a long term evolution (LTE) protocol, a worldwide interoperability for microwave access (WiMAX) protocol or a device-to-device (D2D) protocol. The transmission unit 160 is coupled to the processing unit 120, and the transmission unit 220 is coupled to the processing unit 240.

In an embodiment, the display unit 180 coupled to the processing unit 120 may be one of a liquid crystal display (LCD), a light emitting diode (LED) display, an organic light emitting diode (OLED) display, a cathode ray tube (CRT) display or a plasma display. Further, in another one embodiment of the disclosure, the display unit 180 may be integrated with the touch control panel and implemented in the electronic apparatus 100 as a touch display unit.

In an embodiment, both of the electronic apparatus 100 and the server apparatus 200 may include a storage unit (not illustrated) respectively coupled to the processing units 120 and 240. To be more specific, the storage unit may include various forms of non-transitory, volatile, and non-volatile memories such as one or a combination of a stationary or mobile random access memory (RAM), a read-only memory (ROM), a flash memory, a hard drive or other similar devices. The storage unit would store buffered or permanent data and compiled programming codes used to execute functions of the exemplary electronic apparatus 100 and server apparatus 200.

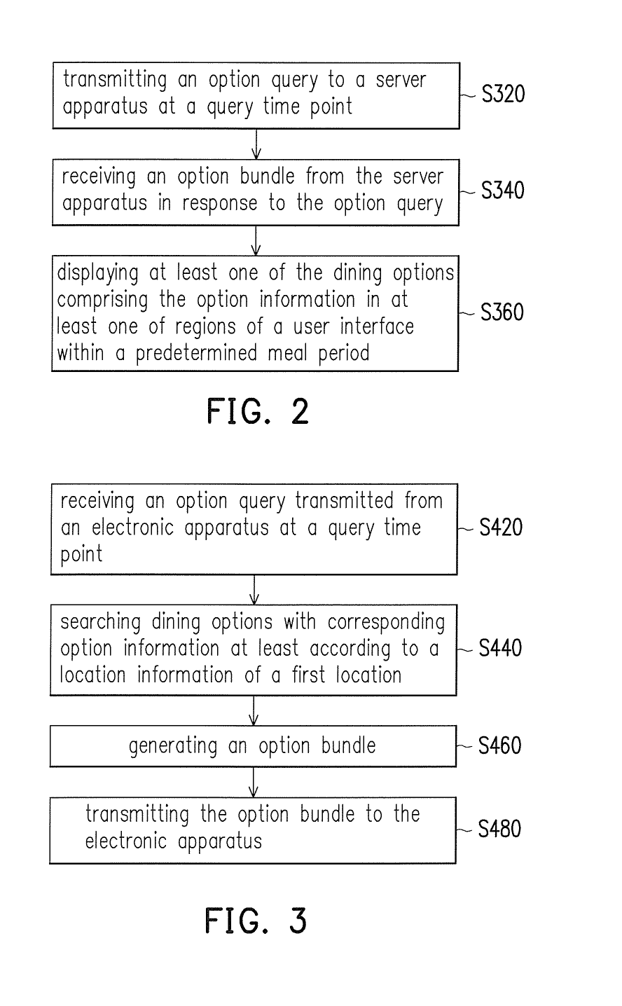

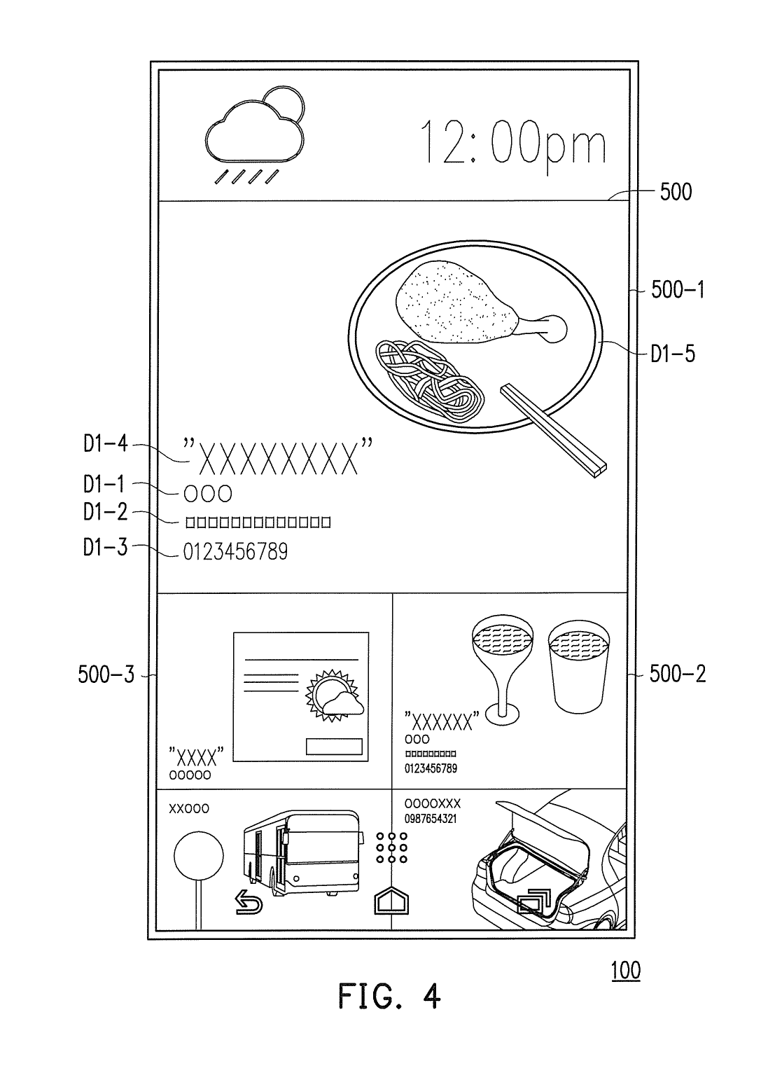

FIG. 2 is a flowchart illustrating a method of providing recommended dining options according to an embodiment of the present disclosure. FIG. 3 is a flowchart illustrating a method of selecting recommended dining options according to an embodiment of the present disclosure. The steps of FIG. 2 could be implemented by the proposed electronic apparatus 100 as illustrated in FIG. 1. Moreover, the steps of FIG. 3 could be implemented by the proposed server apparatus 200 as illustrated in FIG. 1. From FIG. 1, FIG. 2, and FIG. 3, a complete recommendation mechanism for recommending dining options to user of the electronic apparatus 100 is depicted.

Referring to FIG. 1 and FIG. 2, at a query time point, the transmission unit 160 of the electronic apparatus 100 transmits an option query to the server apparatus 200 (step S320). The option query at least includes location information of a first location where the electronic apparatus 100 is located before or at the query time point and the current location information of the electronic apparatus 100 is retrieved at the query time point. Here, the processing unit 120 of electronic apparatus 100 controls the transmission unit 160 to transmit its location information to the server apparatus 200 and asks for the recommended dining options nearby. The first location and the location information may be obtained from Global Positioning System (GPS) and/or other locating system built in the electronic apparatus 100, but it is not limited herein.

Referring to FIG. 1 and FIG. 3, after the option query is sent out by the electronic apparatus 100 at the query time point, the transmission unit 220 of the server apparatus 200 receives the option query transmitted from the electronic apparatus 100 (step S420). Since the option query includes the location information of the first location where the electronic apparatus 100 is located at the query time point, the processing unit 240 of the server apparatus 200 then searches the dining options information at least according to the location information of the first location (Step S440), wherein the dining option comprising at least one option information corresponding to the dining option.

Specifically, in the present embodiment, the processing unit 240 first searches available dining options with the related option information from one or various network resources, such as websites, blogs, databases, or other similar resources, based on contextual data of the location information contained in the option query. The aforementioned network resources may be specialized in food review or food recommendation. The processing unit 240 may search the available dining options by comparing coordinates or addresses of various dining spots recorded in the network resources with the first location. In one embodiment, if the distance between the first location and the dining spot is lower than a threshold, than the dining spot is selected as one of the available dining options by the processing unit 240. In contrast, if the distance between the first location and the dining spot is not lower than the distance threshold, than the dining spot is not selected by the processing unit 240. In an embodiment of the present disclosure, the distance threshold may be, for example, 500 meters or 1 kilometer.

The location information may not only indicates the coordinates or the address of the first location. In addition, the option query not only includes the location information of the first location. In an embodiment of the present disclosure, the location information may further include the information related to the first location, for example the country where the first location is located or the weather condition of the first location. Further, in another embodiment of the present disclosure, the option query further includes preference information which may be automatically determined by a software program or set by the user of the electronic apparatus 100. As the result, in the present embodiment, the processing unit 240 of the server apparatus 200 may search the available dining options from the various network resources based on contextual data of the location information and the preference information contained in the option query. For example, the preference information may include religion information of the user of the electronic apparatus 100. If the user is a Hindu devotee, the processing unit 240 may also avoid the dining spots that serving beef being the available dining options. If the user is a vegetarian, the processing unit 240 may provide the recommend the dining spots with vegetarian food. Through the location information and the preference information, the available dining options searched by the server apparatus 200 are the most moderate options for the user of the electronic apparatus 100.

When the dining spot recorded in a network resource is selected as the available dining option, the processing unit 240 of the server apparatus 200 may further collect the corresponding option information from that network resource. The information content of the option information may include the name, the address, the contact number, the comment, and the photos related to the available dining option. After all the available dining options are obtained, the processing unit 240 may select a portion of the available dining options as the dining options. The processing unit 240 may select the dining options according to, for example, distance between each of the dining options and the first location, the average cost of each of the dinging option, or the rating of each of the dining options. For example, the processing unit 240 may select several dining options from all the available dining options, wherein the selected dining option corresponding to the dining spots that are closest to the first location, but it is not limited herein. In another embodiment of the present disclosure, the processing unit 240 may treat all the available dining options as the dining options.

In another embodiment of the present disclosure, if the dining options corresponding to the same dining spot are searched from different network sources, the processing unit 240 will reserve the dining option searched from one of the network sources and excludes the dining options searched from the rest of the network sources, and, in an embodiment, integrate all the option information of each dining option from different network sources corresponding to the same dining spot to the reserved dining option, such that there will not be duplicate dining options for the same dining spot to present to the user.

In an embodiment of the present disclosure, the server apparatus 200 may further control the frequency of displaying the recommended dining options on the electronic apparatus 100. The processing unit 220 of the server apparatus 200 determines an option display frequency according to the amount of available dining options related to the first location, and imports the option display frequency to the electronic apparatus 100, such that the electronic apparatus 100 follows the option display frequency to display the dining option when it is located at the first location. Under such condition, even the predetermined meal period is reached, the dining option may not be displayed, so that the user will not receive the same dining option too often.

Referring to FIG. 1 and FIG. 3, the processing unit 240 of the server apparatus 200 generates an option bundle (step S460), where the option bundle includes the dining options. Next, the option bundle is transmitted to the electronic apparatus 100 by the transmission unit 220 of the server apparatus 200 (step S480). In an embodiment, the dining options in the option bundle are further stored to the storage unit of the server apparatus 200 by the processing unit 240.

Referring to FIG. 1 and FIG. 2, after the option bundle is sent out from the server apparatus 200, the transmission unit 160 of the electronic apparatus 100 receives the option bundle from the server apparatus 200 in response to the option query (step S340). The option bundle includes the dining options. Next, the display unit 180 displays at least one of the dining options comprising the option information in at least one of the regions of a user interface within a predetermined meal period (step S360). In an embodiment, the dining option in the option bundle are further stored to the storage unit of the electronic apparatus 100 by the processing unit 120.

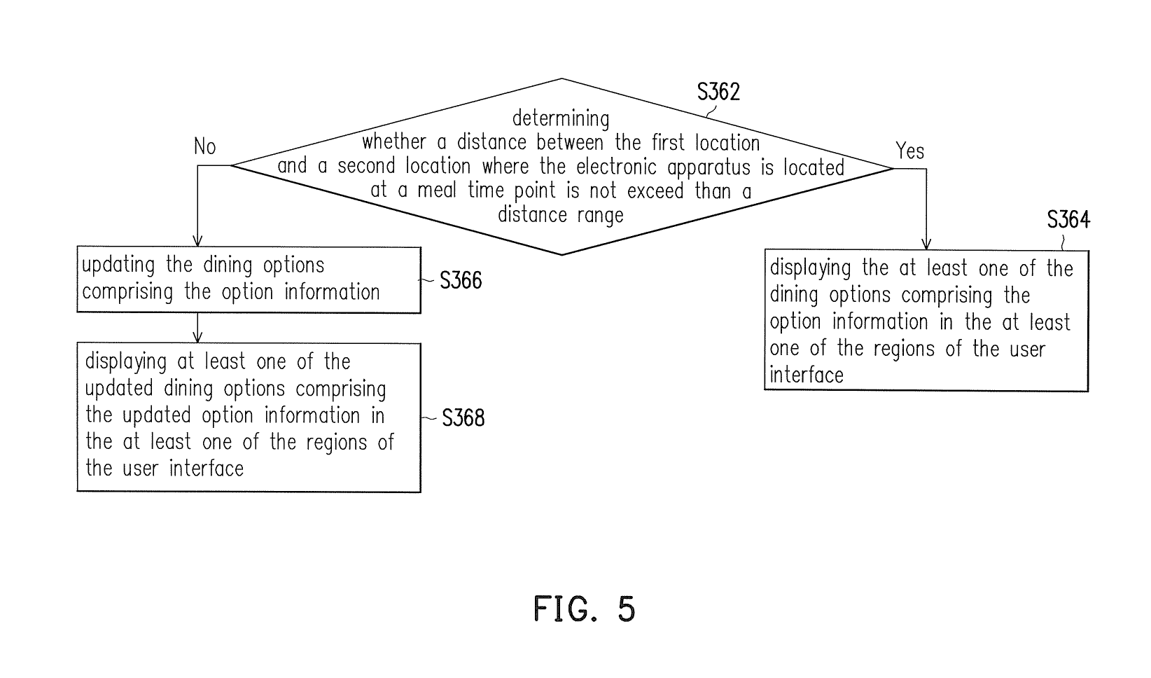

FIG. 4 is a schematic diagram illustrating displaying dining options in regions of a user interface according to an embodiment of the present disclosure. In an embodiment of the present disclosure, a user interface is applied to display information content collected by the electronic apparatus 100 on the display unit 180. Referring to FIG. 4, the user interface 500 is composed of a plurality of regions, such as regions 500-1, 500-2, and 500-3. Each region, such as regions 500-1, 500-2, and 500-3, of the user interface 500 is respectively applied to display information content of the information collected from various network resources. The display unit 180 may only display a portion of the regions of the user interface 500, and the user may slide, scroll, or drag the user interface 500 though the I/O interface 140 to change the regions of the user interface 500 being displayed by the display unit 180.

To be more specific, the information displayed in the regions 500-1, 500-2, 500-3 of the user interface 500 is collected by the electronic apparatus 100, and the information may be news information, advertisement information, weather information, social network information, calendar information, TV program information, or other similar information. In an embodiment, at least a part of the information content of the option information included in the dining options searched or collected by the server apparatus 200 is also displayed in the regions of the user interface 500 on the display unit 180.

As stated above, the information content of the option information may include the name, the address, the contact number, the comment, and the photos related to the dining option. Referring to FIG. 4, the information, for example the name D1-1, the address D1-2, the contact number D1-3, the comment D1-4, and the photo D1-5, related to one of the dining options is displayed in the region 500-1 on the display unit 180 of the electronic apparatus 100. Further, the information, for example the name, the address, the contact number, the comment, and the photo, related to the another dining option may also be displayed in the region 500-2 on the display unit 180 of the electronic apparatus 100. The number of the dining options displayed in the user interface 500 within the predetermined meal period in the previous embodiment is multiple. In another embodiment, only one dining option with the option information is displayed in one of the regions of the user interface 500 within the predetermined meal period. Further, the photos corresponding to the dining options may be respectively set as the backgrounds of the regions 500-1 and 500-2 or set as the background of the user interface 500.

An example of the user interface 500 comprising the regions may refer to U.S. patent applications Ser. Nos. 61/709,997, 61/750,339, 61/812,217, and Ser. No. 14/044,685.

In the present embodiment, a meal time point, which is an initial time point of the predetermined meal period, is later than the query time point, such that the processing unit 120 may transmit the option query to the server apparatus 200 to obtain the option bundle prior to the meal time point of the predetermined meal period, and then displays the dining option to the user of the electronic apparatus 100 on the display unit 180. The query time point may be, for example, an hour or 30 minutes prior to the meal time point of the predetermined meal period, but it is not limited herein. In an embodiment, the dining option is only displayed during the predetermined meal period, and the dining option is not displayed out of the predetermined meal period. In another embodiment, only the meal time point is predetermined and without the predetermined meal period.

In one embodiment of the present disclosure, the meal time point and the length of the predetermined meal period may be set by the processing unit 240 of the server apparatus 200. The processing unit 240 may determine different predetermined meal periods for different location information and the electronic apparatus 100 may import the predetermined meal period according to the current location of the electronic apparatus 100. Therefore, the predetermined meal period set by the server apparatus 200 may reflect the lifestyle of the area around the current location of the electronic apparatus 100. In another embodiment, the meal time point and the length of the predetermined meal period may be set by the processing unit 120 in the electronic apparatus 100 and preferably according to the current location. In still another embodiment of the present disclosure, the predetermined meal period may be set by the user of the electronic apparatus 100 through the I/O interface 140.

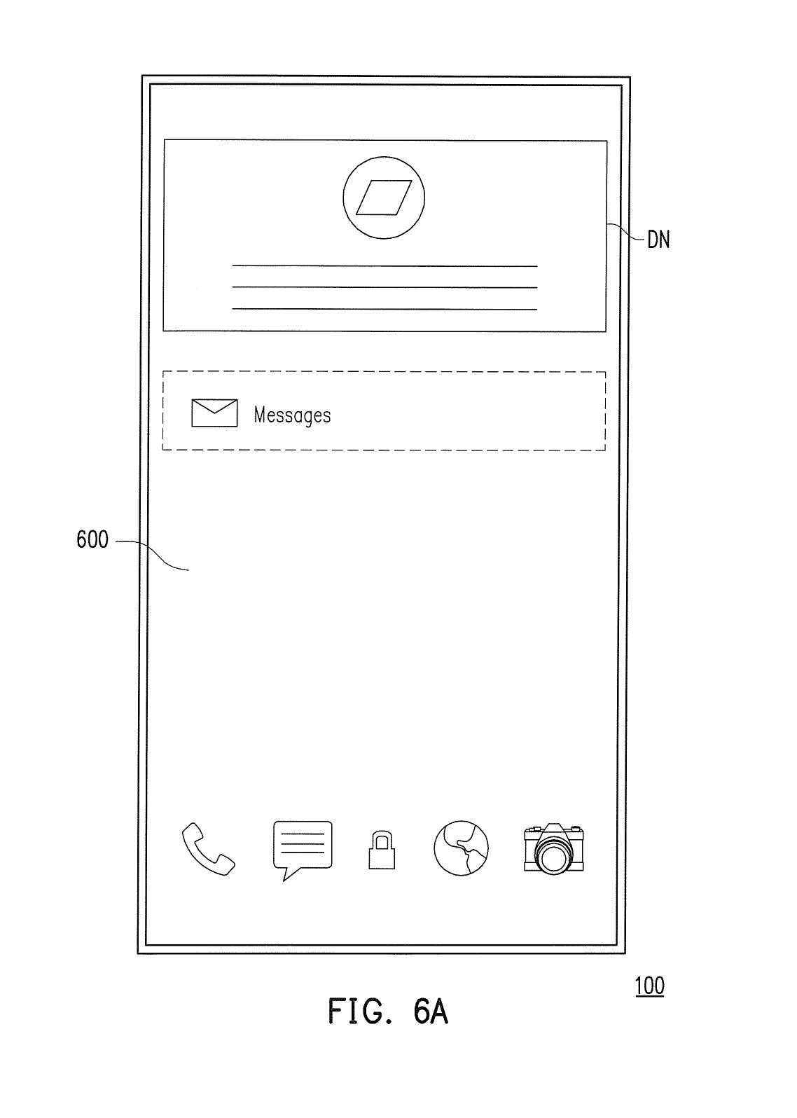

FIG. 5 is a flowchart illustrating steps of displaying dining options in regions of a user interface according to an embodiment of the present disclosure. In the present embodiment, the dining options are obtained through the option bundle before the meal time point of the predetermined meal period. However, taking the mobility of the user into consideration, it is foreseeable for that the user of the electronic apparatus 100 might not stay at the same location all the time. Thus, the first location for receiving the dining options at the time before the meal time point of the predetermined meal period may be different from the current location of the electronic apparatus 100 at the time of the meal time point.

Referring to FIG. 5, in an embodiment of the present disclosure, before displaying the dining options, the electronic apparatus 100 may first determine whether the dining options are still suitable for the user. Specifically, processing unit 120 of the electronic apparatus 100 determines whether a distance between the first location and a second location, where the electronic apparatus 100 is located at the meal time point, not exceed than a distance range (step S362). The distance range may be, for example, 500 meters or 1 kilometer, but it is not limited herein. If the distance between the first location and the second location is not exceed than the distance range, the display unit 180 displays at least one of the dining options in the at least one of the regions of the user interface 500 (step S364). By contrast, if the distance between the first location and the second location is exceed than the distance range, the processing unit 120 updates the dining options (step S366). Then, the display unit 180 displays at least one of the updated dining options (step S368).

To be more specific, the processing unit 120 controls the transmission unit 160 to transmit an option updating query to the server apparatus 200. The option updating query includes location information of the second location. The transmission unit 220 of the server apparatus 200 receives the option updating query, and the processing unit 240 searches the updated dining options at least according to the location information of the second location. The detail of searching the updated dining options can be learned and deduced with the reference of the aforementioned embodiments illustrating the detail of searching the dining options, so it is not illustrated herein.

After the updated dining options are obtained, the processing unit 240 generates an update bundle including the updated dining options, and the update bundle is transmitted to the electronic apparatus 100 by the transmission unit 220. The transmission unit 160 of the electronic apparatus 100 receives the update bundle sent from the server apparatus in response to the option updating query. The processing unit 120 then controls the display unit 180 to display the updated dining options comprising the updated option information within the predetermined meal period.

In an embodiment, while the dining option and option information is displayed in the regions of the user interface 500, the processing unit 120 of the electronic apparatus 100 detects whether any of the regions in the user interface 500 displaying the dining option or option information is selected by the user though the I/O interface 140. If a region in the user interface 500 displaying the dining option or option information is selected through the I/O interface, the processing unit 120 controls the display unit 180 to display detail information of the dining option corresponding to the selected region through an application interface of the application. In an example, the detailed information is displayed in a specific application launched after receiving the selection signal.

To be more specific, in the present embodiment, the information content of the option information displayed in the regions of the user interface 500 is collected from one or various network sources. When the region displaying the dining option or option information is selected by the user of the electronic apparatus 100, the processing unit 120 further directs the user to the original network source where the dining option or option information came from. For example, if the original network source is a website, then the processing unit 120 launches the browser application and displays the detail information of the dining option stated on the website through the browser of the browser application. In another embodiment, if the original network source has a corresponding application installed in the electronic apparatus 100, then the processing unit 120 launches that application and displays the detail information of the dining option on the original network source. In still another embodiment, the user interface 500 is generated by a specific application, after dining option in a region is selected, an another user interface of the specific application for displaying the detail information of the selected dining option will be displayed.

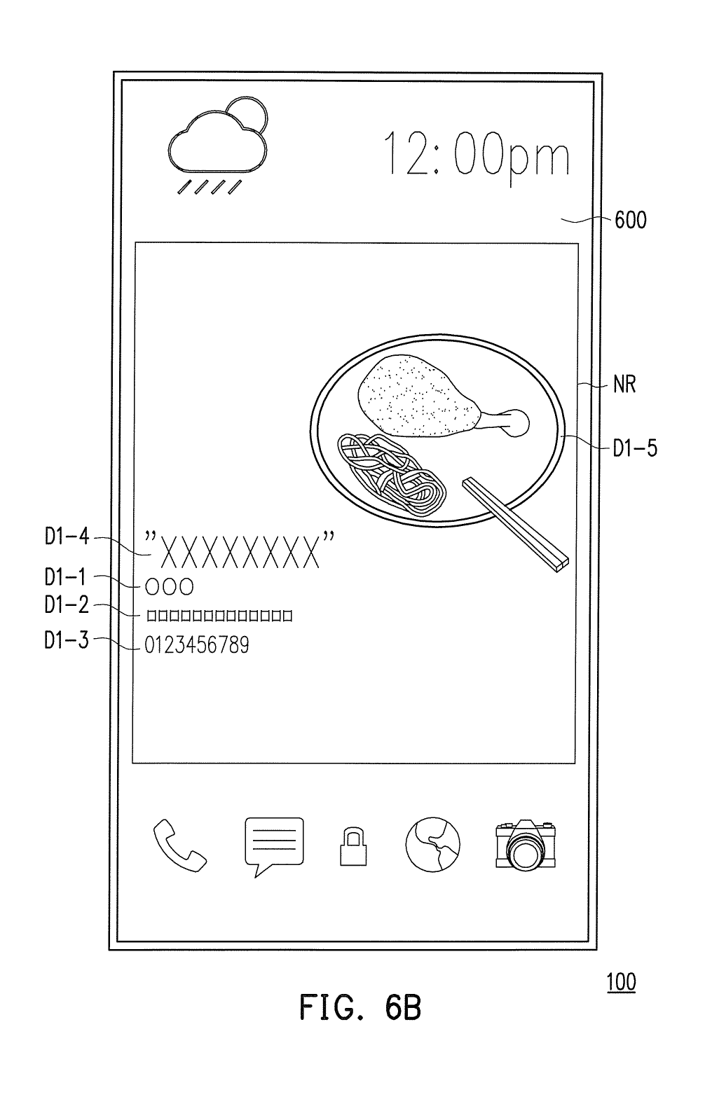

FIG. 6A is a schematic diagram illustrating displaying a dining notification under a lockscreen state according to an embodiment of the present disclosure. FIG. 6B is a schematic diagram illustrating launching a notification region under a lockscreen state according to an embodiment of the present disclosure. Referring to FIG. 6A, after the option bundle is received, when the electronic apparatus 100 is in a lockscreen state at the meal time point of the predetermined meal period, then the display unit 180 displays a dining notification DN on a lockscreen interface 600 within the predetermined meal period. The dining notification DN is applied to notify the user of the electronic apparatus 100 that at least one of the recommended dining options is ready to show for the user.

Referring to FIG. 6B, after the dining notification DN is shown, the processing unit 120 further detects whether the dining notification DN is selected or activated by the user of the electronic apparatus 100 through the I/O interface 140. If the dining notification DN is selected through the I/O interface 140, the processing unit 120 further launches a notification region NR on the lockscreen interface 600, and the display unit 180 displays at least one of the dining options in the notification region NR. For example, the name D1-1, the address D1-2, the contact number D1-3, the comment D1-4, and the photo D1-5 related to the selected dining options are displayed in the notification region NR on the display unit 180 of the electronic apparatus 100. In one embodiment of the present disclosure, the photo D1-5 may further be displayed as the background image on the lockscreen interface 600. In another embodiment, the notification region NR is a user interface of an application corresponding to the selected dining notification DN, and in one embodiment the corresponding application is launched after the dining notification be selected.

In another embodiment of the present disclosure, after the dining notification DN is shown, the processing unit 120 further detects whether the electronic apparatus 100 is unlocked through the I/O interface 140. If the electronic apparatus 100 is unlocked by the user through the I/O interface 140, the display unit 180 displays at least one of dining options in the at least one of the regions of the user interface 500 under the control of the processing unit 120 or in a user interface of an specific application for displaying the dining option

In an embodiment, if the dining option displayed in the lockscreen interface 600 and not selected or activated by the user in the lockscreen interface 600, and then the electronic device 100 is switched to the user interface 500 from the lockscreen interface 600, the dining option will not be displayed in the user interface 500.

In an embodiment, after the option bundle or the update bundle is received by the electronic apparatus 100 through the transmission unit 160, the processing unit 120 may further check the dining options and determine a portion of the dining options that may be displayed in the user interface 500.

To be more specific, in the present embodiment, the processing unit 120 determines whether the electronic apparatus 100 has been located at the dining spots respectively indicated by the dining options according to location records obtained from one or more various applications, for example the application with location recording related function, and the time information or detention periods respectively corresponding to the location records may also be obtained. According to the location records and the corresponding detention periods, the processing unit 120 may determine whether the user of the electronic apparatus 100 has been to one or more of the dining spots indicated by the dining options before or recently.

For example, the electronic apparatus 100 or the server apparatus may get the information of whether the user has been the dining spot before and the time when the user has been the dining spot from check-in information form social network information (e.g., Facebook), tag information with location information from social network service (e.g., Facebook), timeline information from electronic map service (e.g., Google Map), place record information from social network service or electronic map service (e.g., Google Map), calendar information, the record of an order application from for the dining spot, and the like, but is not limited herein. In one embodiment, some record may also be useful for determining whether the user had the meal by taking away. For example, the record of an order application from for the dining spot, and the like, but is not limited herein.

Further, in one embodiment, whether the user actually had a meal by eating in the dining spots rather than just passed by or visited the dining spots will be determined through the information that how long the user stayed in the dining spots will also be considered. To be more specific, if the time that the user stayed in the dining spot exceed a time threshold, than it will be determined that the user had a meal there before or recently and the priority to displayed these dining options will be low.

The display unit 180 may only display the dining options which corresponding to the dining spots that the electronic apparatus 100 has not been located at for an endurance period in the regions of the user interface 500 or the dining options that the electronic apparatus 100 has never been located at there before. The endurance period may be, for example, a week or a month, but it is not limited herein.

In another embodiment, the dining option that has been displayed in a prior period or was displayed before will be excluded, and then the display unit 180 displays rest of the dining options in the user interface 500 and/or lockscreen state with the predetermined meal period. The prior period may be the period that prior to the predetermined meal period from the meal time point, and the duration of the prior period may be, for example, one week or one month, but it is not limited herein.

In still another embodiment, if there is a coupon event or sales event for a dining spot, the dining option correspond to the dining spot will still be displayed to the user even the electronic apparatus 100 has been the dining spot before or recently and with high priority to display than the other received dining options.

In an embodiment, the processing unit 120 further determines whether the predetermined meal period is overlapped with an appointment period of an appointment event recorded in an application. In other words, the processing unit 120 determines whether the user of the electronic apparatus 100 has to join an event during the predetermined meal period according to, for example, calendar information, task information, social network service event information, etc. If the predetermined meal period is not overlapped with the appointment period, then the display unit 180 displays the dining options within the predetermined meal period. However, if the predetermined meal period is overlapped with the appointment period, the processing unit 120 prevents the display unit 180 from displaying the dining options. In one embodiment, if the predetermined meal period is overlapped just a part with the appointment period, the dining options with the location close to the location of the appointment will be displayed to the user. In another embodiment, if the predetermined meal period is not overlapped but the time is close to the appointment period, the dining options with the location close to the location of the appointment will be displayed to the user. To be more specific, the dining options with the location close to the location of the appointment may be determined by determining whether the distance between the locations of the dining option and the appointment is within a predetermined range.

The disclosure also provides a non-transitory computer readable medium, which records computer program to be loaded into an electronic apparatus to execute the steps of the method of providing recommended dining options. The computer program is composed of a plurality of program instructions (for example, an organization chart, establishing program instruction, a table approving program instruction, a setting program instruction, and a deployment program instruction, etc.), and these program instructions are loaded into the electronic apparatus and executed by the same. In one embodiment, the non-transitory computer readable medium may be downloaded by the user from as application store.

Based on the description above, the disclosure is directed to a technique for automatically recommending user of the electronic apparatus with suitable dining options. The dining options and the corresponding option information are searched at least based on the location information of the electronic apparatus and displayed though a user interface on the electronic apparatus within the predetermined meal period. Thus, the disclosure provides a convenient and instinctive recommendation mechanism.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of providing recommended dining options, adapted to an electronic apparatus connected to a server apparatus, the method comprising:
transmitting an option query to the server apparatus at a query time point, wherein the option query comprises location information of a first location where the electronic apparatus is located at the query time point;
receiving an option bundle from the server apparatus in response to the option query, wherein the option bundle comprising one or more dining option comprising option information; and
displaying at least one of the dining options comprising the option information in at least one of regions of a user interface within a predetermined meal period, wherein the regions of the user interface are applied to display information content collected by the electronic apparatus.

2. The method according to claim 1, wherein the step of displaying at least one of the dining options comprising the option information in the at least one of regions of the user interface further comprises:
determining whether a distance between the first location and a second location where the electronic apparatus is located at a meal time point is not exceed than a distance range;
in response to determining the distance between the first location and the second location is not exceed than the distance range, displaying the at least one of the dining options comprising the option information in the at least one of the regions of the user interface; and
in response to determining the distance between the first location and the second location is exceed than the distance range, updating the dining options comprising the option information, and displaying at least one of the updated dining options comprising the updated option information in the at least one of the regions of the user interface.

3. The method according to claim 2, wherein the step of updating the dining options comprising the option information further comprises:
transmitting an option updating query to the server apparatus, wherein the option updating query comprises location information of the second location; and
receiving an update bundle from the server apparatus in response to the option updating query, wherein the update bundle comprises the updated dining options comprising the updated option information.

4. The method according to claim 1, further comprising:
detecting whether the region in the user interface displaying the option information is selected; and
in response to detecting the region in the user interface displaying the option information is selected, launching an application and displaying detail information of the dining option corresponding to the selected region through an application interface of the application.

5. The method according to claim 1, further comprising:
entering a lockscreen state and entering a next predetermined meal period; and
displaying one of one or more new dining notification received for the next predetermined meal period on a lockscreen interface within the next predetermined meal period.

6. The method according to claim 5, further comprising:
after the dining notification for the next predetermined meal period is displayed, detecting whether the dining notification for the next predetermined meal period is selected; and
in response to detecting the dining notification is selected, launching a notification region on the lockscreen interface and displaying the dining option corresponding to the selected dining notification comprising the option information in the notification region.

7. The method according to claim 5, further comprising:
after the dining notification is displayed for the next predetermined meal period, detecting whether the dining notification for the next predetermined meal period is selected before the electronic apparatus is unlocked; and
in response to detecting the dining notification for the next predetermined meal period is not selected before the electronic apparatus is unlocked, displaying the dining option for the next predetermined meal period in the regions of the user interface.

8. The method according to claim 1, wherein the step of displaying the at least one of the dining options comprising the option information in the at least one of the regions of the user interface further comprises:
according to location records and corresponding information of time of stay obtained from an application with location recording related function to determine whether the electronic apparatus has been located at dining spots respectively indicated by the dining options; and
displaying the at least one of the dining options comprising the option information which corresponding to at least one of the dining spots that the electronic apparatus has not been located at for an endurance period in the at least one of the regions of the user interface.

9. The method according to claim 1, wherein the step of displaying the at least one of the dining options comprising the option information in the at least one of the regions of the user interface further comprises:
determining whether the predetermined meal period is overlapped with an appointment period of an appointment event;
in response to determining the predetermined meal period is not overlapped with the appointment period, displaying the at least one of the dining options comprising the option information; and
in response to determining the predetermined meal period is overlapped a part with the appointment period, displaying the at least one of the dining options comprising the option information with the location close to the location of the appointment.

10. The method according to claim 1, wherein the step of displaying the at least one of the dining options comprising the option information in the at least one of the regions of the user interface further comprises:
excluding the dining option comprising the option information in the option bundle that has been displayed in a prior period; and
displaying rest of the dining options comprising the option information in the at least one of the regions of the user interface within the predetermined meal period.

11. An electronic apparatus, connected to a server apparatus, the electronic apparatus comprising:
a processing unit;
an input/output (I/O) interface, coupled to the processing unit;
a transmission unit, coupled to the processing unit, transmitting an option query to the server apparatus at a query time point, and receiving an option bundle from the server apparatus in response to the option query, wherein the option query comprises location information of a first location where the electronic apparatus is located at the query time point, and wherein the option bundle comprises one or more dining options comprising option information; and
a display unit, coupled to the processing unit, displaying at least one of the dining options comprising the option information in at least one of regions of a user interface within a predetermined meal period, wherein the regions of the user interface are applied to display information content collected by the processing unit.

12. The electronic apparatus according to claim 11, wherein the processing unit determines whether a distance between the first location and a second location where the electronic apparatus is located at a meal time point is not exceed than a distance range,
in response to determining the distance between the first location and the second location is not exceed than the distance range, the display unit displays the at least one of the dining options comprising the option information in the at least one of the regions of the user interface,
in response to determining the distance between the first location and the second location is exceed than the distance range, the processing unit updates the dining options comprising the option information, and the display unit displays at least one of the updated dining options comprising the updated option information in the at least one of the regions of the user interface.

13. The electronic apparatus according to claim 11, wherein the processing unit detects whether the region in the user interface displaying the option information is selected through the I/O interface,
in response to detecting the region in the user interface displaying the option information is selected through the I/O interface, the processing unit launches an application and the display unit displays detail information of the dining option corresponding to the selected region through an application interface of the application.

14. The electronic apparatus according to claim 11, wherein the processing unit controls the electronic apparatus to enter a lockscreen state and enter a next predetermined meal period, and the display unit displays one of the one or more dining notification received for the next predetermined meal period on a lockscreen interface within the next predetermined meal period.

15. The electronic apparatus according to claim 14, wherein after the dining notification for the next predetermined meal period is displayed by the display unit, the processing unit detects whether the dining notification for the next predetermined meal period is selected through the I/O interface,
in response to detecting the dining notification is selected through the I/O interface, the processing unit launches a notification region on the lockscreen interface and the display unit displays the dining option corresponding to the selected dining notification comprising the option information in the notification region.

16. The electronic apparatus according to claim 14, wherein after the dining notification for the next predetermined meal period is displayed by the display unit, the processing unit detects whether the dining notification for the next predetermined meal period is selected through the I/O interface before the electronic apparatus is unlocked,
in response to detecting the dining notification for the next predetermined meal period is not selected before the electronic apparatus is unlocked through the I/O interface, the display unit displays at least one of the dining options comprising the option information in the at least one of the regions of the user interface.

17. The electronic apparatus according to claim 11, wherein the processing unit determines whether the electronic apparatus has been located at dining spots respectively indicated by the dining options according to location records and corresponding information of time of stay obtained from an application with location recording related function,
the display unit displays the at least one of the dining options comprising the option information which corresponding to at least one of the dining spots that the electronic apparatus has not been located at for an endurance period in the at least one of the regions of the user interface.

18. The electronic apparatus according to claim 11, wherein the processing unit determines whether the predetermined meal period is overlapped a part with an appointment period of an appointment event recorded in an application,
in response to determining the predetermined meal period is not overlapped with the appointment period, the display unit displays the at least one of the dining options comprising the option information,
in response to determining the predetermined meal period is overlapped with the appointment period, the processing unit displays the at least one of the dining options comprising the option information with the location close to the location of the appointment.

19. The electronic apparatus according to claim 11, the processing unit excludes the dining option comprising the option information in the option bundle that has been displayed in a prior period, and the display unit displays rest of the dining options comprising the option information in the at least one of the regions of the user interface within the predetermined meal period.

20. A non-transitory computer readable medium, storing programs to be loaded into an electronic apparatus to perform steps of:
transmitting an option query to the server apparatus at a query time point, wherein the option query comprises location information of a first location where the electronic apparatus is located at the query time point;
receiving an option bundle from the server apparatus in response to the option query, wherein the option bundle comprising one or more dining option comprising option information; and
displaying at least one of the dining options comprising the option information in at least one of regions of a user interface within a predetermined meal period, wherein the regions of the user interface are applied to display information content collected by the electronic apparatus.
